(19) United States
(12) Patent Application Publication
(10) Pub. No.: US 2024/0033053 A1
(43) Pub. Date: Feb. 1, 2024

(54) INTEGRATED TISSUE MANAGEMENT SOLUTIONS IN ORTHODONTIC ALIGNERS

(71) Applicant: Align Technology, Inc., San Jose, CA (US)

(72) Inventors: David Francisco GARRUBBA, Mortsel (BE); Magdalena BLANKENBURG, San Jose, CA (US)

(21) Appl. No.: 18/358,908

(22) Filed: Jul. 25, 2023

Related U.S. Application Data
(60) Provisional application No. 63/392,445, filed on Jul. 26, 2022.

(51) Int. Cl. A61C 8/00; A61C 7/08

(52) U.S. Cl. CPC A61C 8/0093; A61C 7/08; A61C 2008/0084

(57) ABSTRACT

Methods and apparatuses for managing soft tissue in preparation for a restorative implant procedure. The methods and apparatuses may be used shape the soft tissue in a manner that improves an emergence profile of the restorative implant, thereby providing a natural-looking and protective base for the implant. The apparatuses may include a tissue shaping feature, which may be used with one or more dental aligners, to apply a tissue shaping pressure to the soft tissue. The methods may be integrated with orthodontic treatment planning systems to provide a specialized treatment plan.

### CLAIM OF PRIORITY

This patent application claims priority to U.S. Provisional Patent Application No. 63/392,445, titled “INTEGRATED TISSUE MANAGEMENT SOLUTIONS IN ORTHODONTIC ALIGNERS,” and filed on Jul. 26, 2022, herein incorporated by reference in its entirety.

### INCORPORATION BY REFERENCE

All publications and patent applications mentioned in this specification are herein incorporated by reference in their entirety to the same extent as if each individual publication or patent application was specifically and individually indicated to be incorporated by reference.

### BACKGROUND

Dental implants are prosthesis that implanted into the jaw to restore functionality and/or appearance of a patient's dentition. Examples of dental implants may include dental crowns, bridges and dentures. Dental implants typically include an artificial crown, an implant body and an implant abutment, and may also include an abutment fixation screw. The implant body is surgically inserted in the jawbone in place of a tooth root. The implant abutment can be attached to the implant body by the abutment fixation screw, and extend through gingiva to support the attached artificial crown.

One of the factors associated with the dental implant procedures relates to providing a seamless integration of the dental implant with the soft tissue in the patient's mouth. This can be quantified by what's referred to as an emergence profile, which refers to the contour of the dental implant where it meets, or “emerges” from the gingiva. The creation of natural esthetic contours signifies that both the tooth and supporting tissue are in harmony. A good emergence profile may not only necessary to achieve an esthetic tooth restoration, but may also be necessary to protect the implant and bone from external factors. For example, a poor emergence profile may be associated with infiltration of food and bacteria, which may cause peri-implantitis or may even result in bone loss.

One technique that dentists use to create good emergence profile is implementation of a healing abutment. Healing abutments are temporarily devices that are put in place of a tooth during the healing process after the tooth has been extracted. However, these healing abutments are generally small and have shapes that do not reflect the natural geometry of the tooth. In some cases, the tooth implant and/or healing abutment may put too much tension on the gingiva, thereby causing the gums to resorb due to too much pressure and insufficient blood supply. Further, the small size of the healing abutment may make the wound site vulnerable to infiltration of food and bacteria during the healing process. These factors may all contribute to hindering the creation of a good emergence profile for the restoration implant.

What is needed, therefore, are improved methods and apparatuses related to soft tissue and restoration implants.

### SUMMARY OF THE DISCLOSURE

Described herein are methods and apparatuses (e.g., systems and devices) relate to tissue management in restorative dental treatments. The methods may involve the use of dental appliances that apply forces on soft tissue (e.g., gingiva) to prepare the soft tissue for the restorative dental treatment, such as implantation of a dental implant. In some cases, the dental appliances also apply repositioning forces on one or more teeth of the patient's dentition to reposition the one or more teeth toward a target position.

The dental apparatuses may include one or more tissue shaping features configured to condition and shape a patient's gingiva in preparation for the dental implant. The tissue shaping features may be part of a dental aligner (e.g., shell aligner), or may be configured to cooperate with one or more aligners, to apply a shaping pressure on a patient's soft tissue (e.g., gingiva) at an implant site. The dental aligners may be configured to be removably placed on a patient's dental arch. The tissue shaping feature (e.g., in cooperation with the aligner) may be configured to apply the shaping pressure on the soft tissue in a manner that causes the soft tissue to take on a pre-determined shape. The shaping pressure may be gentle enough to allow sufficient blood supply to the soft tissue, thereby preventing resorption of the soft tissue. The predetermined shape of the tissue shaping feature may substantially correspond to a contour of the dental implant where it meets or “emerges” from the gingiva, also referred to as an emergence profile of the dental implant. Once the soft tissue is shaped and the dental implant is implanted, the result may be a natural-looking transition from the soft tissue to the dental implant.

The dental apparatuses described herein may be configured to apply repositioning forces to one or more teeth of the patient. The repositioning forces may reposition the one or more teeth from an initial position(s) to a target position(s). In some cases, the repositioning forces reposition one or more teeth adjacent to the tooth extraction region to provide room for the tooth implant. Alternatively or additionally, the repositioning forces reposition may be applied to straighten the one or more teeth of the patient's dentition.

In some cases, the treatment involves the use of a system of dental apparatuses (e.g., dental aligners). The system may include a series of dental apparatuses that are configured to incrementally apply forces on the teeth according to an orthodontic treatment plan. At least one of the aligners of the series of aligners may include a tissue shaping feature (e.g., pontic) that is configured to apply shaping forces to the patient's soft tissue in preparation for the restorative implant. For example, in some cases, a first aligner of the series of aligners may not include a tissue shaping feature, and a second aligner of the series of aligners may include a tissue shaping feature. In some cases, all of the aligners in the series of aligners includes a tissue shaping feature.

The apparatuses may include software analysis tools, which may be part of a dental treatment planning system for determining or modifying an orthodontic treatment plan. The methods and tools may be part of a system for generating and/or executing a dental treatment plan. The methods and tools may be configured to generate virtual models of a patient's initial/current dentition, target dentition and/or orthodontic appliances (e.g., aligners). The methods and tools may be configured to generate instructions for fabricate one or more physical orthodontic appliances (e.g., aligners) based on the virtual orthodontic appliances (e.g., aligners).

According to some aspects, a dental apparatus configured to create an emergence profile for a tooth implant comprises: a shell configured to be removably placed on a patient's dental arch, the shell having an inner surface defining a plurality of cavities shaped and sized to accept teeth of the patient's dental arch, wherein the inner surface is configured to apply a repositioning force to at least one tooth of the patient's dental arch to reposition the at least one tooth from an initial position to a target position according to an orthodontic treatment plan; and a tissue shaping feature configured to apply a shaping pressure to a gingiva interface region of the patient's gingiva, wherein the tissue shaping feature is configured to shape the gingiva interface region of the patient's gingiva toward a shape that complements a shape of the tooth implant.

In some examples, the tissue shaping feature may be attached to the shell. In some examples, the shaping pressure may be sufficiently low to permit vascularization of gingival tissue at the gingiva interface region. In some examples, at least a portion of the tissue shaping feature may have a shape that corresponds to the shape of an implant interface surface of the tooth implant. In some examples, the shell and/or the tissue shaping feature may be configured to reposition one or more teeth adjacent to an implant site to provide room for the tooth implant. In some examples, the shell may be configured to reposition the at least one tooth to straighten the at least one tooth. In some examples, the shell may be configured to reposition the at least one tooth to straighten the at least one tooth, and wherein the shell and/or the tissue shaping feature is/are configured to reposition one or more teeth adjacent to an implant site to provide room for the tooth implant. In some examples, the tissue shaping feature may comprise a crown portion having a shape corresponding to a crown of the tooth implant. In some examples, the tissue shaping feature may comprise a crown portion having a shape that is different than a crown of the tooth implant. In some examples, the shell may cooperate with the tissue shaping feature to apply the shaping pressure to the gingiva interface region of the patient's gingiva.

According to some aspects, an orthodontic system configured to create an emergence profile for a tooth implant comprises: a series of aligners configured to implement an orthodontic treatment plan on a patient's dentition, each of the aligners of the series of aligners configured apply repositioning forces on one or more teeth of the patient's dentition in accordance with a stage of the orthodontic treatment plan, wherein at least one aligner of the series of aligners includes a tissue shaping feature configured to apply a shaping pressure to an implant site, wherein the tissue shaping feature is configured to shape the gingiva at the implant site toward a shape that complements at least a portion of the tooth implant.

In some examples, a first aligner of the series of aligners may not include a corresponding tissue shaping feature, and a second aligner of the series of aligners may include a corresponding tissue shaping feature. In some examples, a first set of aligners of the series of aligners may be configured to reposition one or more teeth adjacent to the implant site to provide space for the tooth implant, and a second set of aligners may include the tissue shaping feature to shape the gingiva at the implant site. In some examples, the shaping pressure may be sufficiently low to permit vascularization of gingival tissue at the implant site. In some examples, at least a portion of the tissue shaping feature may have a shape that corresponds to a shape of an implant interface surface of the tooth implant. In some examples, the tissue shaping feature may be coupled to the at least one aligner such that the tissue shaping feature is removable from the patient's mouth along with the at least one aligner. In some examples, the tissue shaping feature may be configured to engage with the at least one aligner. In some examples, the tissue shaping feature may be configured to engage with a healing abutment attached to a body portion of the tooth implant that is implanted within the patient's jaw. In some examples, the tissue shaping feature may comprise a crown portion having a shape corresponding to a crown of the tooth implant. In some examples, the crown portion may have a shape corresponding to a shape of an extracted tooth. In some examples, the tissue shaping feature may have a color that matches a color of an extracted tooth or other teeth of the patient.

According to some aspects, a method of create an emergence profile for a tooth implant comprises: implanting a body portion of the tooth implant into a patient's jaw at an implant site; repositioning one or more teeth of the patient using a series of aligners, wherein each aligner of the series of aligners includes a polymeric shell having a plurality of cavities shaped and sized to accept the patient's teeth, wherein an inner surface of the polymeric shell applies a repositioning force to the one or more teeth of the patient in accordance with a stage of a treatment plan; shaping the patient's gingiva at the implant site by applying a shaping pressure on the patient's gingiva using a tissue shaping feature coupled to at least one of the aligners of the series of aligners, wherein the tissue shaping feature shapes a gingiva interface region of the patient's gingiva toward a shape that complements a shape of the tooth implant; and attaching a crown portion of the tooth implant to body portion of the tooth implant, wherein the crown portion of the tooth implant interfaces with the shaped gingiva interface region of the patient's gingiva to form the emergence profile of the tooth implant.

In some examples, the tissue shaping feature may comprise a crown portion having a shape corresponding to the crown portion of the tooth implant. In some examples, the crown portion of the tissue shaping feature may have a shape corresponding to a shape of an extracted tooth. In some examples, the tissue shaping feature may have a color that matches a color of an extracted tooth or other teeth of the patient. In some examples, the tissue shaping feature may engage with a healing abutment attached to the body portion of the tooth implant and that extends above the patient's gingiva at the implant site.

According to some aspects, a non-transient, computer-readable medium containing program instructions for forming a dental apparatus is configured to create an emergence profile for a tooth implant, where the program instructions cause a processor to: generate a jaw model and a tissue shaping feature model, wherein the jaw model includes virtual models of the teeth and gingiva of a patient's jaw, and wherein at least a crown portion the tissue shaping feature model has a shape corresponding to a shape of a crown portion of the tooth implant; receive user instructions to move the tissue shaping feature model into an implant site of the jaw model to determine whether there is enough space for the crown portion of the tissue shaping feature model over the implant site; and generate a series of aligner models configured to apply repositioning forces on one or more of teeth of the jaw model to reposition the one or more teeth toward a target position, wherein at least one aligner model of the series of aligner models includes the tissue shaping feature model, wherein the tissue shaping feature model is arranged to apply a shaping pressure to shape the gingiva at the implant site.

In some examples, the program instructions may further comprise generating instructions to manufacture a series of aligners based on the series of aligner models, wherein at least one aligner of the series of aligners includes a tissue shaping feature corresponding to the tissue shaping feature model. In some examples, the program instructions may further comprise receiving user instructions to position a body portion model of the tooth implant into the jaw model at the implant site. In some examples, generating the series of aligner models may comprise calculating the repositioning forces based on a target dentition and a series of intermediate stages toward accomplishing the target dentition from a pre-treatment dentition. In some examples, generating the series of aligner models may comprise calculating the shaping pressure based on the shaping pressure being sufficiently high to shape the gingiva at the implant site and sufficiently low to permit vascularization of the gingiva at the implant site.

All of the methods and apparatuses described herein, in any combination, are herein contemplated and can be used to achieve the benefits as described herein.

### BRIEF DESCRIPTION OF THE DRAWINGS

A better understanding of the features and advantages of the methods and apparatuses described herein will be obtained by reference to the following detailed description that sets forth illustrative embodiments, and the accompanying drawings of which:

FIG. 1 illustrates a combined section view of half of a natural tooth (left) and a tooth implant (right), showing respective emergence profiles.

FIG. 2 illustrates an aerial view of an example extraction region of gingiva after removal of a healing abutment.

FIG. 3 illustrates an aerial view of another example extraction region of gingiva after removal of a tissue shaping feature.

FIG. 4 illustrates a side view of an extracted tooth model.

FIGS. 5A-5E illustrate various views of a 3D model of a patient's jaw showing different aspects of forming a tissue shaping feature and aligner.

FIG. 6 illustrates a view inside a patient's mouth where there is not enough space to implant a tooth implant.

FIG. 7 illustrates a side view of a tooth being extracted between two teeth.

FIG. 8 is a flowchart indicating aspects of an example restorative tooth implant process that includes creating an emergence profile for the tooth implant.

FIG. 9 is a flowchart illustrating aspects of an example process of forming one or more aligners with a tissue shaping feature.

FIG. 10 is a diagram showing an example data structure for a soft tissue management for restorative implant tool.

### DETAILED DESCRIPTION

The methods and apparatuses described herein relate to dental treatment plans that involve the management of soft tissue (e.g., gingiva) in preparation for a dental restoration, such as a dental implant. Examples of dental implants may include prosthesis such as a crown, bridge, denture, or other dental implant. The methods may involve the use of one or more dental appliances that are configured to apply pressure on the soft tissue at the implant site in a manner that shapes the tissue in preparation for the implant. The applied pressure may also prevent or reduce tissue resorption. Once the tissue is shaped and conditioned, the dental implant may be implanted, and the tissue may support and surround the implant in a natural-looking and protective manner.

One goal of treatment may include conditioning and shaping the soft tissue such that the soft tissue takes on a shape that is complementary to a shape of the implant that has been implanted, thereby providing a good emergence profile. In general, an emergence profile of an implant may refer to contour of the implant where it meets, or emerges from the gingiva. A good emergence profile may provide a natural-looking and smooth transition between the gingiva and the implant, thereby providing esthetic contours and protecting the underlyingly tissue of the patient.

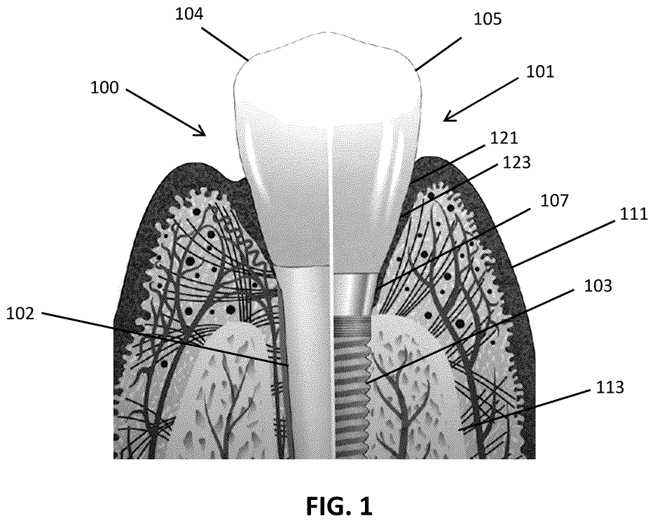

FIG. 1 illustrates a comparison of an emergence profile a tooth implant 101 (right side) and an emergence profile of a natural tooth 100 (left side). In this case, the tooth implant 101 includes a body 103 (which may include a fixation screw), a crown 105, and a dental implant abutment 107. The body 103 may be surgically implanted into the jawbone 113. The body 103 may roughly mimic a root 102 of the natural tooth 100, and the implant crown 105 may mimic the crown 104 of the natural tooth 100. In some cases, the implant crown 105 may have a shape that is substantially the same as the crown 104 of the natural tooth 100. For example, the implant crown 105 may be fabricated based on a digital model of the crown 104 of an extracted tooth.

As shown, an implant interface surface 121 of the tooth implant 101 interfaces with a gingiva interface region 123 of the gingiva 111. For example, the tooth implant 101 and the gingiva 111 may interface at those surface portions of the tooth implant 101 and the gingiva 111 where the gingiva 111 contacts and/or extends above the bottom of the crown 105 of the tooth implant 101. The emergence profile of the tooth implant 101 may refer to the contour of the tooth implant 101 where it emerges from the gingiva 111. A good emergence profile may provide a natural-looking transition from the gingiva 111 to the tooth implant 101, for example, when viewed from facial and/or lateral views. In some cases, this may mimic the emergence profile of the natural tooth 100 where it emerges from the gingiva 111.

The emergence profile of the implant 101 may involve both the shape of the tooth implant 101 and how far the implant 101 is placed below the bone 113 and gingiva 111 relative to adjacent teeth. In some cases, the emergence profile 121 may be related to an angle at which the implant emerges from the gingiva. If the gingiva 111 are too thin, the gingiva 111 may not contact any of the crown 105, or only contact of a lower portion of the of the crown 105. In which case, the implant 101 may have an emergence profile that is sufficiently different than that of the natural tooth 100. That is, gingiva 111 that is too thin may not result in an emergence profile that appears a smooth, natural-looking transition from the gingiva 111. Further, gingiva 111 that is too thin may allow infiltration of food and bacteria between the gingiva 111 and the implant 101, which may result in peri implantitis and bone loss.

To create a good emergence profile, the gingiva interface region 123 of the gingiva 111 may have a shape that complements the shape of the implant interface surface 121 of the tooth implant 100, such as shown in the example of FIG. 1. In addition, the gingiva 111 may extend towards the apex of the crown 105 of the tooth implant 101 to about the same extent as the gingiva 111 extends towards the apex of the crown 104 of the natural tooth 100.

The shape of the gingiva 111 may be modified during the tooth implant procedure. In some examples, a tooth implant procedure may include cutting the gingiva 111 to expose the jawbone 113, and drilling a hole into the jawbone. Next, the body portion 103 (also referred to as a post) of the tooth implant 101 may be implanted in the hole. Once implanted, it may take several months for the body 103 to properly fuse (e.g., osseointegrate) with the jawbone 113 and provide a solid base. A healing abutment (not shown) may be temporarily attached to the abutment 107 at the end of the body 103 during a healing process. The methods described herein may include the use of a tissue shaping feature (not shown) that is configured to apply a tissue shaping pressure against the gingiva 11 to shape the gingiva 111 (e.g., around the healing abutment). The tissue shaping feature may be removable from the healing abutment so that the patient may, for example, clean the area around the implant site (e.g., around the healing abutment). In some examples, the tissue shaping feature may be used in conjunction with (e.g., attached to) one or more orthodontic aligners that are configured to apply repositioning forces on one or more teeth of the patient's dentition. In some cases, the repositioning forces may be applied to the teeth concurrently with the tissue shaping pressure being applied to the gingiva 111. In other cases, the repositioning forces and the tissue shaping pressure may be applied separately. For example, the tissue shaping pressure may be applied before and/or after repositioning teeth.

The tissue shaping feature may have a shape corresponding to the shape of the implant interface surface 121. Since the gingiva 111 heals around the healing abutment and the tissue shaping feature, the gingiva interface region 123 of the gingiva 111 may take on a shape that complements the shape of the implant interface surface 121. Once the gingiva is sufficiently shaped and healed, the healing abutment may be replaced with the crown portion 105 of the tooth implant 101. Since the gingiva interface region 123 has a shape that complements the shape of the implant interface surface 121, the result is a tooth implant 101 with a good emergence profile.

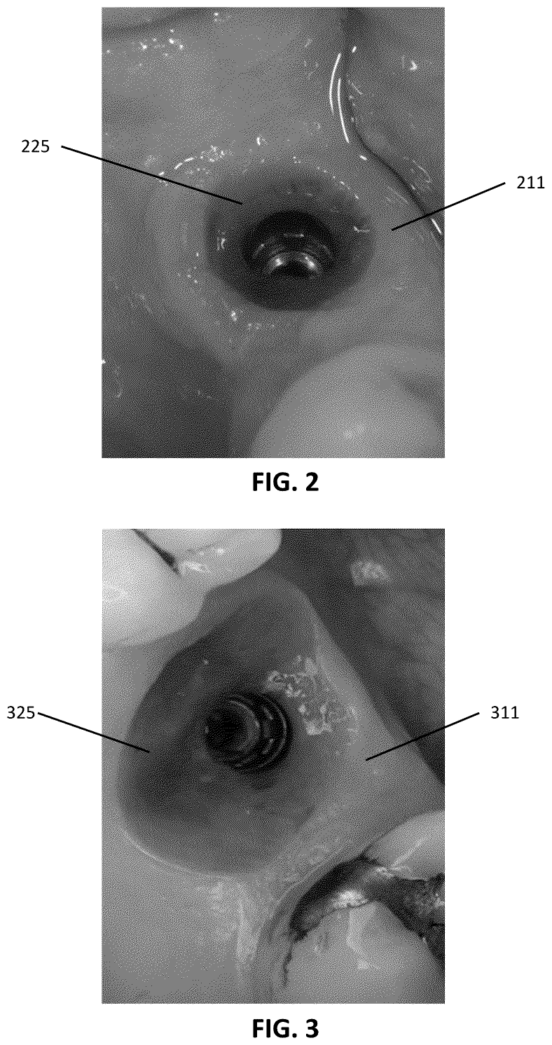

FIG. 2 shows an example extraction region of gingiva 211 after removal of a healing abutment without the use of a tissue shaping feature. As shown, a gingiva interface region 225 of the gingiva 211 takes on a round shape that complements a round shape of the healing abutment.

FIG. 3 shows another example extraction region gingiva 311 after use a tissue shaping feature having a customized shape. In this case, the customized shape of the tissue shaping feature corresponds to a surface shape of a portion of the expected tooth implant (e.g., implant interface surface 121 in FIG. 1). The tissue shaping feature may be configured to apply pressure to the gingiva interface region 325 in a manner that allows the gingival tissue to heal around the tissue shaping feature. This may cause the gingiva interface region 325 to take on shape/contour that complements the implant interface surface of the expected tooth implant. In addition, the gingiva interface region 325 is depressed deeper within the gingiva 311 compared to the gingiva interface region 225 of FIG. 2. This may allow the gingiva 311 to extend more toward the apex of the tooth implant compared to the gingiva 211. These factors may allow the gingiva interface region 325 to better interface with the tooth implant compared to the round shaped gingiva interface region 225, thereby providing a more natural-looking transition between the gingiva 311 and the tooth implant (i.e., better emergence profile). In addition, the improved interface may improve prevention of infiltration of food and bacteria between the gingiva 311 and the tooth implant.

The tissue shaping feature may have a shape that complements the shape of at least a portion of the expected tooth implant. To accomplish this, the tissue shaping feature may be fabricated based on a virtual (e.g., digital) model of the tooth implant. The virtual model may be a virtual 3D model. In some cases, the shape of the tooth implant may mimic that of the extracted tooth. In other cases, the shape of the tooth implant may be based on another tooth of the patient or a generic tooth (e.g., from a library of tooth models).

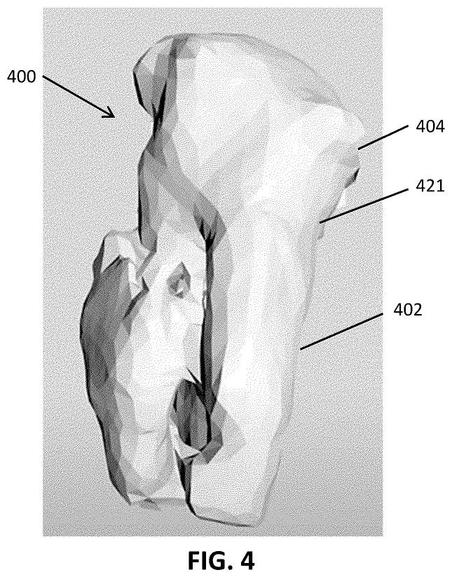

FIG. 4 shows an example of an extracted tooth model 400. The extracted tooth model 400 may be a virtual 3D model of the extracted tooth. In this example, the extracted tooth model 400 provides an outer surface contour of a crown 404, and at least a rough estimate of an outer surface contour of a root 402. An implant interface surface 421 may be part of the crown 404 (e.g., lower portion of the crown 404 near the root 402). The extracted tooth model 400 may be obtained, for example, from one or more dental scans of the patient's dentition prior to extraction. For example, the tooth model 400 may be isolated from one or more scans of the patient's full dentition prior to extracting the tooth. The dental scan(s) may include any of a number of types of dental scans. In some cases, the dental scan(s) may involve scanning using visible, near infrared, infrared, ultraviolet and/or x-ray radiation. In one example, the dental scan(s) is/are collected using cone-beam computed tomography (CBCT).

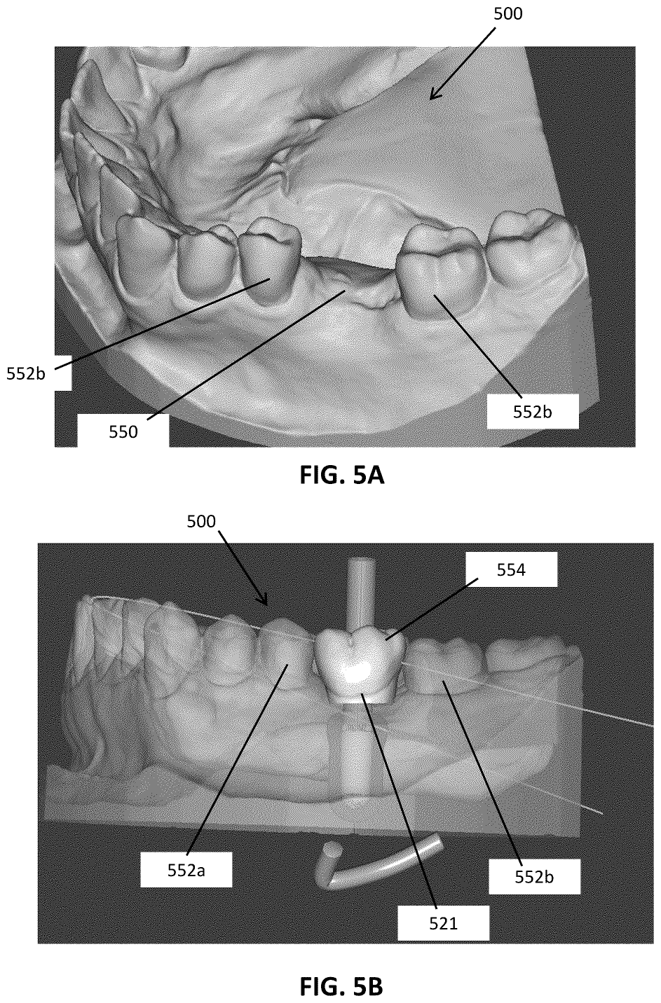

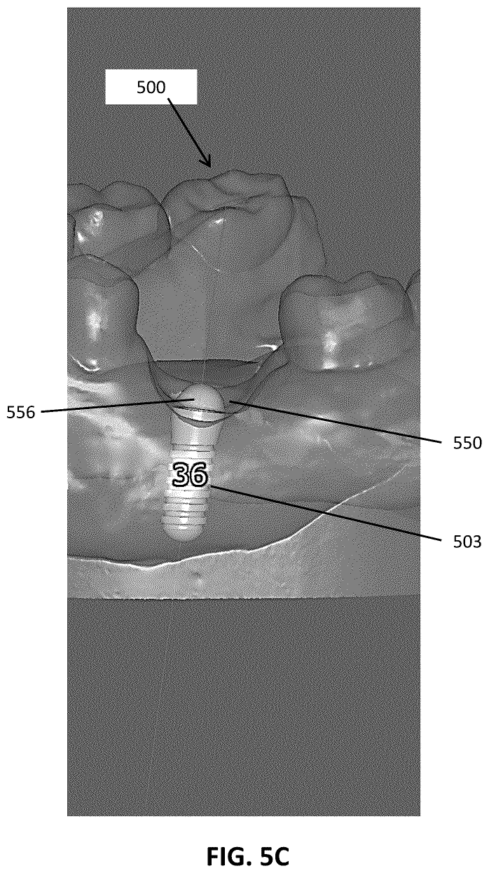

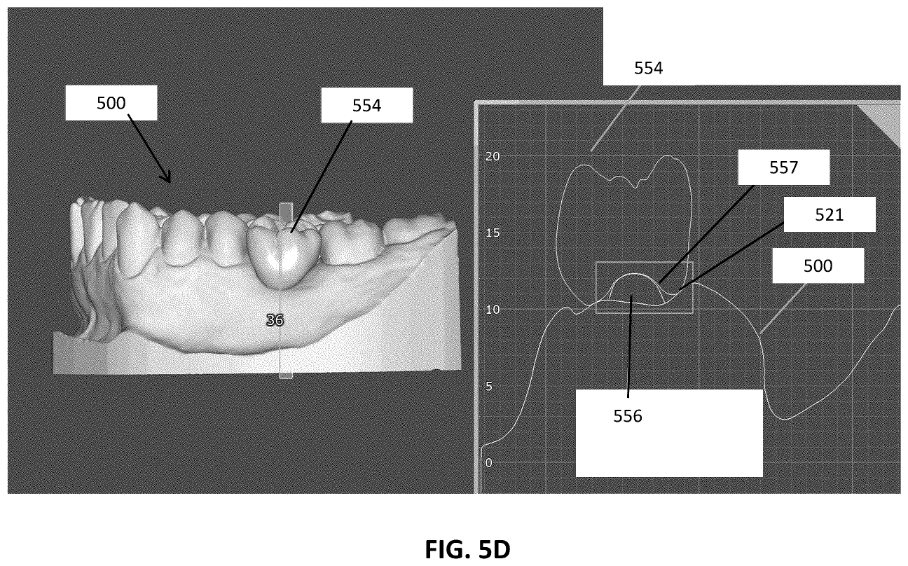

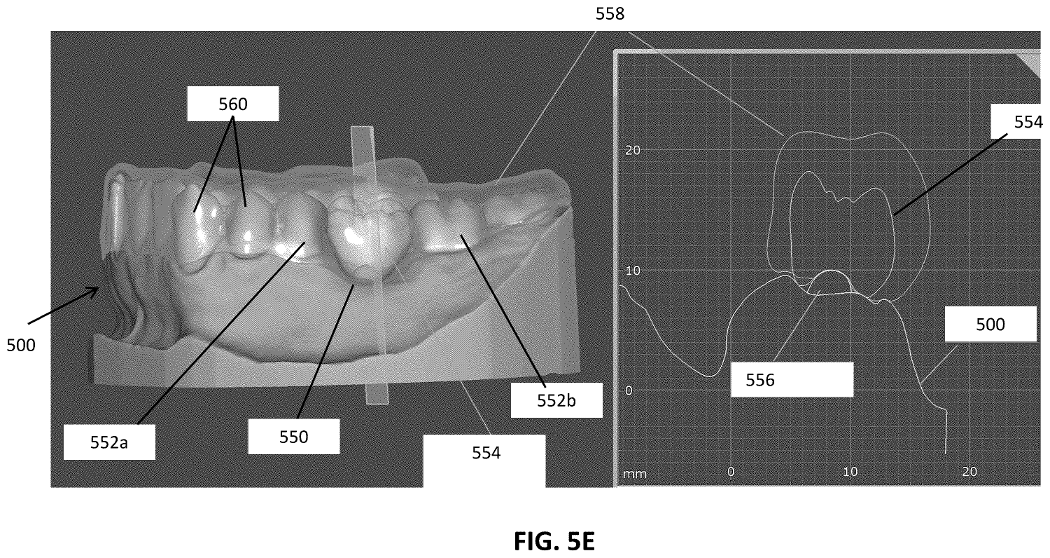

Once a virtual model of the tooth implant is obtained, it may be integrated into a virtual model of the patient's dentition at an implant site (e.g., the extraction site from which a natural tooth has been extracted) of the patient's jaw. FIG. 5A shows a virtual 3D model of a patient's jaw 500 having an implant site 550 after extraction of a tooth. The jaw model 500 may be obtained based on one or more scans of the patient's dentition, for example using visible, near infrared, infrared, ultraviolet and/or x-ray radiation. In some cases, the jaw model 500 may be obtained using the same scanning technology (and be in the same data format) as used to obtain the tooth implant model (e.g., extracted tooth model 400). In other cases, the jaw model 500 may be obtained using a different scanning technology (and be in a different data format) as used to obtain the tooth implant model (e.g., extracted tooth model 400). If the jaw model 500 and the tooth implant model are in different data formats, the data format of the tooth implant model may be converted to the same format as that of the jaw model 500.

In some cases, one or both teeth 552a and/or 552b adjacent to the implant site 550 may encroach into the implant site 550 such that there is insufficient room for tooth implant within the implant site 550. This may occur, for example, when the patient waits a period of time after extraction of the tooth before deciding to replace it with a prosthetic tooth, in which time the positions of one or both of the teeth 552a and/or 552b have shifted toward the implant site 550. Thus, one task may involve determining whether there is enough space at the implant site 550 for the tooth implant. This may be accomplished by measuring and comparing the space between adjacent teeth 552a and 552b to a width of the tooth implant model.

If it is determined that movement of one or both of the teeth 552a and 552b is required to make room for the tooth implant, the required movement may be calculated into an orthodontic treatment plan. Once the jaw 500 is adjusted to move the positions of one or both of the teeth 552a and 552b (if required), a tissue shaping feature model 554 may be inserted into the implant site 550, as shown in FIG. 5B. The position of the tissue shaping feature model 554 may also be adjusted relative to the jaw 500 to assure a good fit may be established.

In this case, the tissue shaping feature model 554 has a shape that correspond to the crown shape of the expected tooth implant (which may also correspond to the crown shape of the extracted tooth (e.g., 400)). In some examples, the tissue shaping feature manufactured from the tissue shaping feature model 554 has a color that matches that of patient's natural teeth (e.g., the extracted tooth or other teeth of the patient). Thus, the tissue shaping feature may visibly mimic the tooth implant when worn by the patient. This may provide the aesthetic advantage of providing a realistic looking tooth and hiding the implant site 550. An implant interface surface 521 of the tissue shaping feature model 554 may have a shape corresponding that of the implant interface surface 521 of the expected tooth implant, thereby shaping the gingiva to have a complementary shape.

The orthodontic treatment plan may additionally or alternatively include movement of one or more teeth in the jaw 500 other than the teeth 552a and 552b adjacent to the tissue shaping feature model 554. For example, the orthodontic treatment plan may include straightening the position of one or more teeth of the jaw 500 for aesthetic and/or functional purposes. Such tooth movement(s) may be calculated into the orthodontic treatment plan.

The restoration treatment may include the use of a healing abutment in addition to a tissue shaping feature. FIG. 5C shows an example implant body model 503 implanted into the jaw 500 with a healing abutment model 556 attached to the top of the implant body model 503. As shown, the healing abutment model 556 may positioned within the gingiva and extend above the gingiva at the implant site 550. The healing abutment model 556 may be chosen from a library of healing abutment models specialized for cooperating with removable dental appliances (e.g., aligners). For example, the healing abutment model 556 may have an engagement surface that is shaped and sized to engage with a corresponding one or more aligners.

Once the healing abutment 556 is positioned in the jaw model 500, the tissue shaping feature model 554 may be positioned over the healing abutment model 556, as shown in FIG. 5D. The shape of the interface surface 521 (e.g., lower portion) of the tissue shaping feature model 554 may be positioned to assure that proper pressure is placed on the gingiva at the implant site 550. The pressure should be sufficiently high to cause reshaping of the gingiva and sufficiently low to allow blood flow to the gingiva and prevent resorption. In some cases, a predetermined pressure (or pressure range) may be estimated (e.g., calculated) by the orthodontic treatment planning software. In addition, the lower portion of the tissue shaping feature model 554 may be modified to assure proper engagement with the healing abutment model 556. In this example, the lower portion of the tissue shaping feature model 554 may be modified to include an indentation 557 that is shaped to accept a top surface of the healing abutment model 556.

FIG. 5E shows an aligner model 558 positioned over the jaw model 500 and the tissue shaping feature model 554. The aligner model 558 has an inner surface defining cavities (e.g., 560) for accepting the teeth of the jaw model 500, and configured to apply repositioning forces to one or more teeth of the jaw model 500 toward target position(s). For example, the aligner model 558 may be configured to reposition one or both of the teeth 552a and 552b adjacent to the implant site 550 to make room for the tissue shaping feature model 554.

Once the shapes of the aligner model 558 and tissue shaping feature model 554 are finalized, they may be used as a basis to form a physical aligner and tissue shaping feature. In some cases, the tissue shaping feature is attached to (e.g., integrated with) the aligner such that the tissue shaping feature is removable from the patient's mouth along with the aligner. This may allow the patient to remove the aligner, for example, to periodically clean the implant site 550. Once the gingiva at the implant site 550 has been sufficiently shaped and healed and/or the teeth have been sufficiently repositioned, the healing abutment 556 may be replaced with the crown portion (e.g., 105) of the tooth implant.

In some examples, the treatment plan includes the use of an orthodontic treatment system having a series of appliances (e.g., aligners) for repositioning one or more teeth from an initial tooth arrangement to a target tooth arrangement. One or more of the appliances in the orthodontic treatment system may include, or be configured to engage with, a tissue shaping feature (e.g., pontic). In some cases, one or more of the appliances of an orthodontic treatment system includes multiple tissue shaping features (e.g., for multiple tooth implants).

Repositioning of the teeth may be implemented in accordance with a prescribed treatment plan for moving the teeth from the initial arrangement toward the target arrangement over a period of time. A treatment plan is typically partitioned into multiple incremental intermediate stages, typically with one aligner associated with each stage. For example, a treatment plan that includes 25 stages may involve the use of 25 aligners. An aligner associated with a particular stage of the treatment plan is configured to move the teeth from a first arrangement at the beginning of the particular stage toward a second arrangement at the end of the particular stage.

The treatment plan may be represented by an initial dentition model, a target dentition, and one or more intermediate dentition models. The initial dentition model may represent the patient's dentition prior to treatment, the target dentition model may represent a desired target dentition at the end of treatment, and the one or more intermediate dentition models may represent the dentition at intermediate stage(s) of the treatment. Once the dentition models are generated, aligners models configured to move the teeth according to each of the dentition models may be formed. For example, intermediate aligner models may be formed based on each of the intermediate dentition models. In some cases, a final aligner model may be formed based on the target dentition model. The repositioning forces that each of the aligner models may apply to achieve the target dentition may be calculated by the orthodontic treatment planning software.

An initial digital model of the patient's dentition (e.g., before treatment) may be obtained by one or more scans of the patient's oral cavity. The scan may capture images of the teeth, soft tissue (e.g., gingiva, palatal tissue, labia, nerves, etc.) and/or bone (e.g., jawbone). In some cases, the scan is used to obtain 3D images of the patient's oral cavity. In some cases, scanning of the patient's oral cavity may involve collecting images of features that are visible and/or not visible to the eye. In some examples, the oral scanner may use visible, infrared and/or near-infrared light. In some cases, one or more scans are collected using cone-beam computed tomography (CBCT).

The dentition models and/or aligner models may be virtual (e.g., digital) models, which are viewable and manipulatable using one or more computers. In some cases, the dentition models are virtual three-dimensional (3D) models of the patient's dentition. Typically, an initial 3D model of the patient's dentition is obtained based on a scan the patient's dentition using a dental scanner. A target 3D model representing a desired configuration of the patient's teeth may be determined based on desired changes from the initial 3D model. Virtual 3D models of aligners may be formed based on 3D dentition models. For example, an aligner model may be virtually formed to fit over a dentition model such that the aligner model has cavities with interior surfaces shaped in accordance with outer surfaces of at least a portion of the teeth of the dentition model.

Physical aligners may be formed based on the virtual aligner models (e.g., via molding or additive manufacturing). Each of the physical aligners may include a polymeric shell that is configured to be removably placed over the patient's dental arch, and which has cavities with inner surfaces shaped to accept the teeth of the dental arch. Walls of the cavities may be shaped and sized to apply repositioning forces on one or more teeth of the dental arch in accordance a stage of the treatment plan.

Progress of the treatment plan may be assessed at any time during the treatment. For example, a practitioner (e.g., doctor, dentist, orthodontist, surgeon) may evaluate the progress of the patient's soft tissue and/or tooth positions during an office visit. If it is determined that the soft tissue and/or tooth positions are not progressing as planned, the treatment plan may be modified to account for lack of progress. In some cases, this may mean including one or more additional stages to the treatment plan.

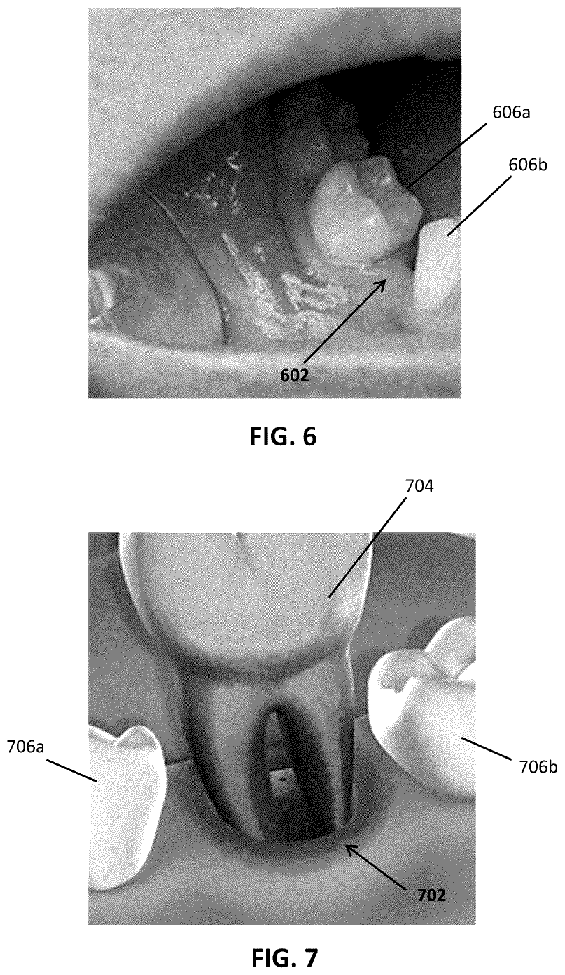

The methods and apparatuses described herein may be used for any of a number of different patient conditions. FIG. 6 illustrates an example patient condition where a patient lost a tooth some time ago (e.g., several months or years). Since some time has passed, the teeth 606a and 606b adjacent to the implant site 602 have moved such that they encroach into the space over the implant site 602, and do not provide enough space for a tooth implant. Further, the gingiva at the implant site 602 has had time to resorb, such that not enough gingival tissue remains to provide a good emergence profile for the tooth implant. To solve these problems, an orthodontic system including a series of aligners having a tissue shaping feature (e.g., pontic), as described herein, may be used. The aligners may be configured to reposition the adjacent teeth 606a and 606b away from the implant site 602 to provide room for the tooth implant. This may be done after implantation of the body (e.g., 103) of the tooth implant (e.g., with abutment 107). The body of the tooth implant may include a healing abutment (e.g., 556) attached thereto. One or more of the aligners of the series of aligners may also include a tissue shaping feature (e.g., pontic 554) to apply a pressure on the gingiva of the implant site 602 sufficient to shape the gingiva and create a gingival interface region at the implant site 602 that complements a shape of the tooth implant, thereby providing a good emergence profile for the implant tooth. The tooth shaping feature may have a shape based on an implant interface surface (e.g., 121 or 421) of the expected tooth implant and/or the extracted tooth (if available).

In some cases, a first set of aligners of the series of aligners may be used to reposition the adjacent teeth 606a and 606b until there is enough space for the tissue shaping feature (e.g., pontic 554). Once there is enough space, subsequent set of aligners may include the tissue shaping feature (or be configured to engage with the tissue shaping feature). In some examples, the series of aligners may additionally be configured to reposition teeth other than the adjacent teeth 606a and 606b, for example, to cosmetically straighten the patient's teeth.

FIG. 7 illustrates another example patient condition where the dentist has extracted a tooth 704 and would like to directly implant the tooth implant. After extraction, the body (e.g., 103) of the tooth implant (e.g., with abutment 107) may be implanted into the jaw at the implant site 702. A healing abutment (e.g., 556) may also be attached to the body of the tooth implant. While the gingiva at the implant site 702 is healing, one or more tissue shaping features (e.g., pontics) may be placed over the implant site 702 to apply shaping forces to create a gingiva interface region having a shape that complements an implant interface surface of the expected tooth implant. The tooth shaping feature(s) may be associated (e.g., attached to) one or more aligners configured to be placed over the patient's dentition. The aligner(s) may be configured to cooperate with the tooth shaping feature(s) to apply the shaping force on the gingiva. The tooth shaping feature may have a shape based on an implant interface surface (e.g., 121 or 421) of the expected tooth implant and/or the extracted tooth 704. In addition, the one or more aligners may be configured to apply forces on teeth 706a and 706b adjacent to the implant site 702 to maintain the space between the teeth 706a and 706b for implanting the tooth implant. In some examples, the one or more aligners may be configured to reposition teeth other than the teeth 706a and 706b, for example, to cosmetically straighten the patient's teeth.

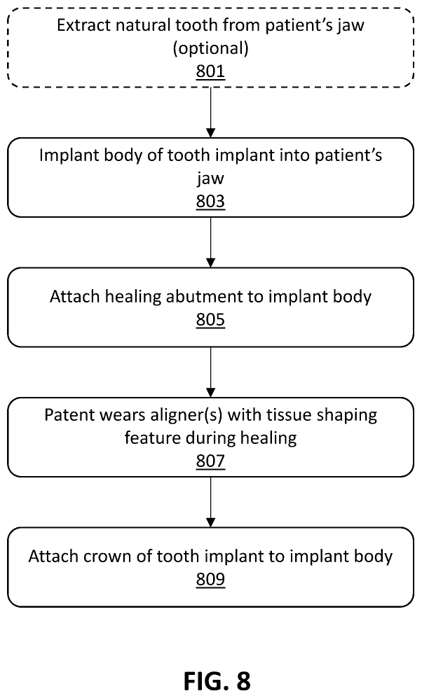

FIG. 8 is a flowchart indicating aspects of an example restorative tooth implant process that includes creating an emergence profile for the tooth implant. At 801, a natural tooth (e.g., diseased tooth) is extracted from an extraction site of the patient. Tooth extraction may be optional. For example, the natural tooth may have already been previously lost or extracted. At 803, a body of the tooth implant is implanted into the patient's jaw. The body of the tooth implant may include an abutment that is configured to attach to a crown of the tooth implant. At 805, a healing abutment is attached to the body (e.g., to the abutment).

At 807, the patient wears one or more tissue shaping features over the healing abutment during healing of bone and/or gingiva after implanting of the body of the tooth implant. The tissue shaping feature may be attached to, or be configured to engage with, one or more aligners that is/are configured to be removable worn on the patient's dentition. The tissue shaping feature may have a shape configured to provide a good emergence profile for the crown portion of the expected tooth implant. For example, at least a portion of the tissue shaping feature may have a shape corresponding to the expected tooth implant. In some cases, the expected tooth implant may have a shape corresponding to the shape of the extracted tooth to provide a natural looking restoration. The tissue shaping feature(s) and the aligner(s) may be configured to apply a shaping force on the gingiva at an implant site (e.g., the extraction site) to shape the gingiva in accordance with a shape that complements the implant interface surface of the tooth implant. The tissue shaping feature may be configured to engage with the healing abutment and encourage tissue healing/growth around the healing abutment and tissue shaping feature. The shaping pressure may be high enough to shape the gingiva and low enough to allow blood flow to the gingiva (thereby reducing or preventing gingival resorption). Additionally, the aligner(s) and/or the tissue shaping feature(s) may be configured to apply a repositioning force against one or more teeth of the patient's dentition. The repositioning forces may be to provide room for the tooth implant and/or to straighten the patient's dentition.

After the gingiva is sufficiently shaped and healed, at 809, the healing abutment may be removed, and a crown portion of the tooth implant may be attached to the body of the implant. Since the gingiva have been shaped to complement the shape of the tooth implant, the result is a natural-looking emergence profile.

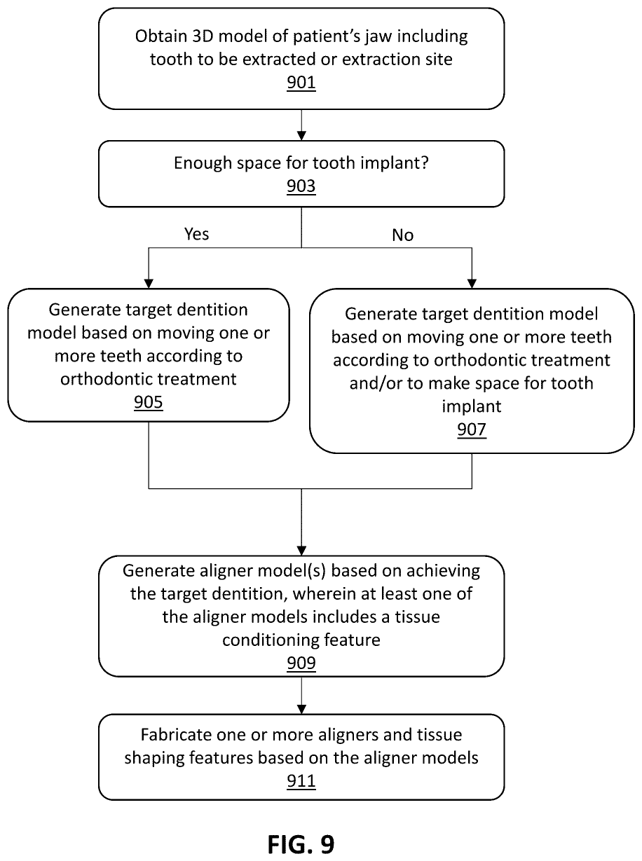

FIG. 9 is a flowchart illustrating aspects of an example process of forming one or more aligners with a tissue shaping feature. At 901, a 3D model (e.g., virtual/digital model) of a patient's jaw including a tooth to be extracted, or an extraction site where a tooth had been extracted, is obtained. The 3D model may be based (e.g., extracted from) on one or more dental scans inside the patient's mouth. At 903, a decision is made as to whether there is enough space for a tooth implant at an implant site (e.g., the extraction site) in the patient's jaw. Such determination may be made by virtually placing a virtual model of the expected tooth implant over the implant site. Additionally or alternatively, measurements may be made on the virtual tooth implant and the space above the implant site (e.g., between teeth) in the jaw model to determine whether the virtual tooth implant will overlap with adjacent tooth/teeth. If it is determined that there is enough space for the tooth implant, at 905 a target dentition model is generated. An orthodontic treatment plan may be generated, which is based moving one or more teeth toward the target dentition according to one or stages. If it is determined that there is not enough space for the tooth implant, at 907 a target dentition model and orthodontic treatment plan includes movement of one or more teeth to make space for the tooth implant.

At 909, one or more aligner models are generated. The aligner model(s) may be shaped and sized to apply repositioning forces on the patient's teeth according to the orthodontic treatment plan and target dentition model at 905/907. In some cases, a series of aligner models is used to achieve the target dentition, where each aligner is configured to incrementally move the patient's dentition according to stages of the treatment plan. At least one of the aligners includes a tissue conditioning feature model that is arranged to apply tissue shaping forces (pressure) on soft tissue. The tissue shaping forces may be applied to the gingiva in a region where the tooth implant will be implanted. The tissue conditioning feature model may cooperate with a corresponding aligner model to apply the tissue shaping forces. For example, the tissue conditioning feature model may engage with and/or be coupled with an aligner model such that the aligner and the tissue conditioning feature work together to apply the tissue shaping forces. The tissue shaping forces may be estimated (e.g., calculated) to apply enough pressure to the gingiva to change a shape of the gingiva, while allowing blood flow to the gingiva to promote gingiva health and growth.

At 911, one or more physical aligners and tissue shaping features are fabricated based on the aligner model(s) and the tissue shaping feature model(s). In some examples, at least a portion of the aligner(s) and the tissue shaping feature(s) is manufactured using an additive manufacturing process (e.g., 3D printing). In some examples, at least a portion of the aligner(s) and the tissue shaping feature(s) is manufactured using a molding process.

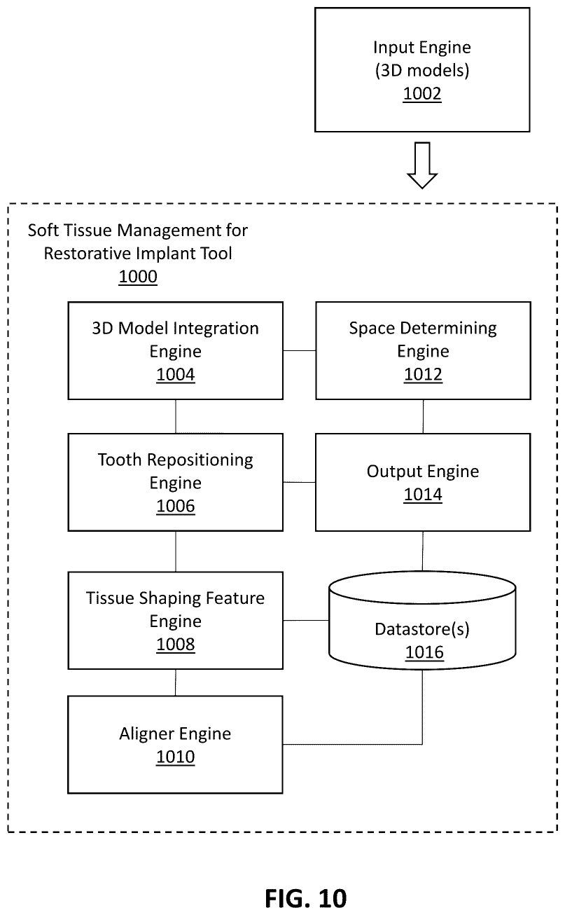

FIG. 10 is a diagram showing an example of a soft tissue management for restorative implant tool 1000. The soft tissue management tool 1000 may be incorporated into a portion of another system (e.g., a general treatment planning system) and may therefore also be referred to as a sub-system. In some cases, the soft tissue management tool 1000 may be an add-on (e.g., plug-in) to the general treatment planning system. In any of the method and apparatuses described herein the soft tissue management tool 1000 may be invoked by a user control, such as a tab, button, etc., as part of treatment planning system, or may be separately invoked. In FIG. 10, the soft tissue management tool 1000 may include a plurality of engines and datastores. As used herein, an engine includes one or more processors or a portion thereof. A portion of one or more processors can include some portion of hardware less than all of the hardware comprising any given one or more processors, such as a subset of registers, the portion of the processor dedicated to one or more threads of a multi-threaded processor, a time slice during which the processor is wholly or partially dedicated to carrying out part of the engine's functionality, or the like. The soft tissue management tool 1000 may include or be part of a computer-readable medium, and may include an input engine 1002 that allows access to data related to a patient and/or a library of data. Such data may include a patient's dental scan data and/or 3D models related to a patient's treatment plan. All or some of the data may be stored in one or more datastores 1016.

In any of these methods and apparatuses (e.g., systems), a computer system can be implemented as an engine, as part of an engine or through multiple engines. As used herein, an engine includes one or more processors or a portion thereof. A portion of one or more processors can include some portion of hardware less than all of the hardware comprising any given one or more processors, such as a subset of registers, the portion of the processor dedicated to one or more threads of a multi-threaded processor, a time slice during which the processor is wholly or partially dedicated to carrying out part of the engine's functionality, or the like. As such, a first engine and a second engine can have one or more dedicated processors, or a first engine and a second engine can share one or more processors with one another or other engines. Depending upon implementation-specific or other considerations, an engine can be centralized, or its functionality distributed. An engine can include hardware, firmware, or software embodied in a computer-readable medium for execution by the processor. The processor transforms data into new data using implemented data structures and methods, such as is described with reference to the figures herein.

The engines described herein, or the engines through which the systems and devices described herein can be implemented, can be cloud-based engines. As used herein, a cloud-based engine is an engine that can run applications and/or functionalities using a cloud-based computing system. All or portions of the applications and/or functionalities can be distributed across multiple computing devices and need not be restricted to only one computing device. In some embodiments, the cloud-based engines can execute functionalities and/or modules that end users access through a web browser or container application without having the functionalities and/or modules installed locally on the end-users' computing devices.

As used herein, datastores 1016 are intended to include repositories having any applicable organization of data, including tables, comma-separated values (CSV) files, traditional databases (e.g., SQL), or other applicable known or convenient organizational formats. Datastores 1016 can be implemented, for example, as software embodied in a physical computer-readable medium on a specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described herein.

The datastores 1016 may include data structures. As used herein, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The datastores 1016, described herein, can be cloud-based datastores. A cloud-based datastore is a datastore that is compatible with cloud-based computing systems and engines.

The soft tissue management tool 1000 may include a computer-readable medium. The modules/engines may be coupled to one another (e.g., example couplings are shown in FIG. 10 by the interconnecting lines) or to modules/engines not explicitly shown in FIG. 10. The computer-readable medium may include any computer-readable medium, including without limitation a bus, a wired network, a wireless network, or some combination thereof. The engine described herein may implement one or more automated agents, including machine learning agents.

A 3D model integration engine 1004 that may integrate various forms of data into a common 3D format that is accessible and manipulatable by a user. For example, input data may include scan data in a first format (e.g., obtained by dentist office) and in a second format (e.g., obtained by surgeon office). In some cases, the various sets of data may be obtained using different types of radiation technologies. For example, a first set of data may be obtained using visible and/or near infrared scanning technology, and a second set of data may be obtained using x-ray technology. In one example, an extracted tooth model is in a first format and a jaw/dentition model is in a second format. The 3D model integration engine 1004 may be configured to integrate these different types of data into a common format that can be displayed and manipulated in 3D. In addition, the 3D model integration engine 1004 may also be configured to integrate 3D models accessed from a library. For example, 3D models of a body portion of an implant tooth, and abutment and/or a healing abutment may be integrated into the 3D model(s) of the patient's jaw model.

A tooth repositioning engine 1006 may manages aspects related to the repositioning of one or more teeth. The tooth repositioning engine 1006 may be configured to generate a target dentition model based on a desired tooth arrangement. The tooth repositioning engine 1006 may also be configured to generate a treatment plan for achieving the target dentition model from a pre-treatment dentition model. For example, the tooth repositioning engine 1006 may be configured to generate intermediate dentition models corresponding to stages of the treatment plan.

A tissue shaping feature engine 1008 may be configured to generate a tissue shaping feature model that is configured to shape soft tissue at an implant site. The tissue shaping feature model may have a shape and size configured to shape the soft tissue in accordance with at least a portion of the expected restoration implant. For example, the tissue shaping feature model may include a surface that correspond to at least an implant interface surface (e.g., 121) of an expected tooth implant. In some examples, the tooth shaping feature may have a crown shape that matches the crown shape of the expected tooth implant. In some examples, the shape of the expected tooth implant may have a shape corresponding to the extracted tooth. The tissue shaping feature engine 1008 may also modify the shape and/or size of the tissue shaping feature, for example, to properly engage with a healing abutment model, and/or features of the soft tissue and/or teeth of the jaw model.

A space determining engine 1012 may be configured to determine (or assist in determining) whether there is enough space for the expected restoration implant. For example, one or more teeth may encroach within a space of the patient's dentition in which a tooth implant is to be implanted. The space determining engine 1012 may include tools to determine the relative sizes and shapes of the expected tooth implant, one or more teeth adjacent to the implant site, and/or the space over the implant site. In some examples, the user may be able to manipulate the virtual 3D models, for example, to place the tissue shaping feature model and/or the expected implant model within the space at the implant site. In some cases, the space determining engine 1012 may be configured to automatically determine whether there is enough space at the implant site by calculating required dimensions at the implant site.

An aligner engine 1010 may be configured to generate one or more aligner models that are configured to apply the repositioning forces to the tooth/teeth. The aligner models may be virtually placed on the model of the patient's jaw with the tissue shaping feature to assure proper fit. The aligner model may be configured to cooperate with the tissue shaping feature model to apply a shaping force (pressure) on the soft tissue and to shape the soft tissue in accordance with the shape of the tissue shaping feature model. The aligner engine 1010 may be used to modify the aligner model(s), for example, by changing the shape of the aligner model(s)), to achieve a desired shaping force on the soft tissue. A desired shaping force may, for example, be forceful enough to affect a shape of the soft tissue and be gentle enough to allow blood flow to/from the soft tissue.

An output engine 1014 may be configured to generate one or more outputs, such as one or more tissue shaping feature models, one or more aligner models and/or one or more treatment plans. The output engine 1014 may access data stored in the datastore 1016. The output may be used in the manufacture of one or more physical dental appliances, such as tissue shaping feature(s) and/or aligner(s). For example, the output may output instructions, or be used as a basis for generating instruction, to fabricate tissue shaping feature(s) and/or aligner(s) via additive manufacturing (e.g., 3D printing) and/or a molding process.

It should be appreciated that all combinations of the foregoing concepts and additional concepts discussed in greater detail below (provided such concepts are not mutually inconsistent) are contemplated as being part of the inventive subject matter disclosed herein and may be used to achieve the benefits described herein.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

Any of the methods (including user interfaces) described herein may be implemented as software, hardware or firmware, and may be described as a non-transitory computer-readable storage medium storing a set of instructions capable of being executed by a processor (e.g., computer, tablet, smartphone, etc.), that when executed by the processor causes the processor to control perform any of the steps, including but not limited to: displaying, communicating with the user, analyzing, modifying parameters (including timing, frequency, intensity, etc.), determining, alerting, or the like. For example, any of the methods described herein may be performed, at least in part, by an apparatus including one or more processors having a memory storing a non-transitory computer-readable storage medium storing a set of instructions for the processes(s) of the method.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the example embodiments disclosed herein.

As described herein, the computing devices and systems described and/or illustrated herein broadly represent any type or form of computing device or system capable of executing computer-readable instructions, such as those contained within the modules described herein. In their most basic configuration, these computing device(s) may each comprise at least one memory device and at least one physical processor.

The term “memory” or “memory device,” as used herein, generally represents any type or form of volatile or non-volatile storage device or medium capable of storing data and/or computer-readable instructions. In one example, a memory device may store, load, and/or maintain one or more of the modules described herein. Examples of memory devices comprise, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “processor” or “physical processor,” as used herein, generally refers to any type or form of hardware-implemented processing unit capable of interpreting and/or executing computer-readable instructions. In one example, a physical processor may access and/or modify one or more modules stored in the above-described memory device. Examples of physical processors comprise, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the method steps described and/or illustrated herein may represent portions of a single application. In addition, in some embodiments one or more of these steps may represent or correspond to one or more software applications or programs that, when executed by a computing device, may cause the computing device to perform one or more tasks, such as the method step.

In addition, one or more of the devices described herein may transform data, physical devices, and/or representations of physical devices from one form to another. Additionally or alternatively, one or more of the modules recited herein may transform a processor, volatile memory, non-volatile memory, and/or any other portion of a physical computing device from one form of computing device to another form of computing device by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media comprise, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

The processor as described herein can be configured to perform one or more steps of any method disclosed herein. Alternatively or in combination, the processor can be configured to combine one or more steps of one or more methods as disclosed herein.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

Throughout this specification and the claims which follow, unless the context requires otherwise, the word “comprise”, and variations such as “comprises” and “comprising” means various components can be co-jointly employed in the methods and articles (e.g., compositions and apparatuses including device and methods). For example, the term “comprising” will be understood to imply the inclusion of any stated elements or steps but not the exclusion of any other elements or steps.

In general, any of the apparatuses and methods described herein should be understood to be inclusive, but all or a sub-set of the components and/or steps may alternatively be exclusive, and may be expressed as “consisting of” or alternatively “consisting essentially of” the various components, steps, sub-components or sub-steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A dental apparatus configured to create an emergence profile for a tooth implant, the dental apparatus comprising:
a shell configured to be removably placed on a patient's dental arch, the shell having an inner surface defining a plurality of cavities shaped and sized to accept teeth of the patient's dental arch, wherein the inner surface is configured to apply a repositioning force to at least one tooth of the patient's dental arch to reposition the at least one tooth from an initial position to a target position according to an orthodontic treatment plan; and
a tissue shaping feature configured to apply a shaping pressure to a gingiva interface region of the patient's gingiva, wherein the tissue shaping feature is configured to shape the gingiva interface region of the patient's gingiva toward a shape that complements a shape of the tooth implant.

2. The dental apparatus of claim 1, wherein the tissue shaping feature is attached to the shell.

3. The dental apparatus of claim 1, wherein the shaping pressure is sufficiently low to permit vascularization of gingival tissue at the gingiva interface region.

4. The dental apparatus of claim 1, wherein at least a portion of the tissue shaping feature has a shape that corresponds to the shape of an implant interface surface of the tooth implant.

5. The dental apparatus of claim 1, wherein the shell and/or the tissue shaping feature is/are configured to reposition one or more teeth adjacent to an implant site to provide room for the tooth implant.

6. The dental apparatus of claim 1, wherein the shell is configured to reposition the at least one tooth to straighten the at least one tooth.

7. The dental apparatus of claim 1, wherein the shell is configured to reposition the at least one tooth to straighten the at least one tooth, and wherein the shell and/or the tissue shaping feature is/are configured to reposition one or more teeth adjacent to an implant site to provide room for the tooth implant.

8. The dental apparatus of claim 1, wherein the tissue shaping feature comprises a crown portion having a shape corresponding to a crown of the tooth implant.

9. The dental apparatus of claim 1, wherein the tissue shaping feature comprises a crown portion having a shape that is different than a crown of the tooth implant.

10. The dental apparatus of claim 1, wherein the shell cooperates with the tissue shaping feature to apply the shaping pressure to the gingiva interface region of the patient's gingiva.

11. An orthodontic system configured to create an emergence profile for a tooth implant, the orthodontic system comprising:
a series of aligners configured to implement an orthodontic treatment plan on a patient's dentition, each of the aligners of the series of aligners configured apply repositioning forces on one or more teeth of the patient's dentition in accordance with a stage of the orthodontic treatment plan,
wherein at least one aligner of the series of aligners includes a tissue shaping feature configured to apply a shaping pressure to an implant site, wherein the tissue shaping feature is configured to shape the gingiva at the implant site toward a shape that complements at least a portion of the tooth implant.

12. The orthodontic system of claim 11, wherein a first aligner of the series of aligners does not include a corresponding tissue shaping feature, and a second aligner of the series of aligners includes a corresponding tissue shaping feature.

13. The orthodontic system of claim 11, wherein a first set of aligners of the series of aligners is configured to reposition one or more teeth adjacent to the implant site to provide space for the tooth implant, and a second set of aligners includes the tissue shaping feature to shape the gingiva at the implant site.

14. The orthodontic system of claim 11, wherein the shaping pressure is sufficiently low to permit vascularization of gingival tissue at the implant site.

15. The orthodontic system of claim 11, wherein at least a portion of the tissue shaping feature has a shape that corresponds to a shape of an implant interface surface of the tooth implant.

16. The orthodontic system of claim 11, wherein the tissue shaping feature is coupled to the at least one aligner such that the tissue shaping feature is removable from the patient's mouth along with the at least one aligner.

17. The orthodontic system of claim 11, wherein the tissue shaping feature is configured to engage with the at least one aligner.

18. The orthodontic system of claim 11, wherein the tissue shaping feature is configured to engage with a healing abutment attached to a body portion of the tooth implant that is implanted within the patient's jaw.

19. The orthodontic system of claim 11, wherein the tissue shaping feature comprises a crown portion having a shape corresponding to a crown of the tooth implant.

20. The orthodontic system of claim 19, wherein the crown portion has a shape corresponding to a shape of an extracted tooth.

21. The orthodontic system of claim 19, wherein the tissue shaping feature has a color that matches a color of an extracted tooth or other teeth of the patient.
